(19) United States
(12) Patent Application Publication
(10) Pub. No.: US 2010/0150121 A1
(43) Pub. Date: Jun. 17, 2010

(54) FIXED MOBILE CONVERGENCE COMMUNICATION APPARATUS USING WIDEBAND VOICE CODEC

(76) Inventors: Woon Seob SO, Daejeon (KR); Hyun Joo BAE, Daejeon (KR); Byung Sun LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/556,682

(22) Filed: Sep. 10, 2009

(30) Foreign Application Priority Data
Dec. 11, 2008 (KR) 10-2008-0126020

(51) Int. Cl. H04W 4/00; H04L 12/66

(52) U.S. Cl. 370/338; 370/352

(57) ABSTRACT

A fixed mobile convergence (FMC) communication apparatus using a wideband audio codec is provided. The FMC communication apparatus includes an application processor which is capable of processing one or more wireless communication protocols and supports a wideband audio codec; a wideband audio signal input/output (I/O) unit which is connected to the application processor and processes the input and output of wideband audio signals; a mobile network access unit which is connected to the application processor and accesses a mobile communication network; and a wireless local area network (LAN) access unit which is connected to the application processor and wirelessly accesses an access point (AP). The FMC communication apparatus can access the base station of a mobile internet system or the base station of a mobile communication system. In addition, the FMC communication apparatus can access a Bluetooth device or an AP using a short-range wireless communication method. Moreover, the FMC communication apparatus can provide high-quality voice call services and various multimedia internet services by using a wideband audio codec.

### CROSS-REFERENCE TO RELATED APPLICATION

This application claims priority from Korean Patent Application No. 10-2008-0126020, filed on Dec. 11, 2008 in the Korean Intellectual Property Office, the disclosure of which is incorporated herein by reference in its entirety.

### BACKGROUND OF THE INVENTION

1. Field of the Invention

The present invention relates to a fixed mobile convergence (FMC) communication apparatus using a wideband voice codec, and more particularly, to an FMC communication apparatus using a wideband voice codec, which can process more than one wireless communication protocol, can support wideband voice codecs, can process wideband voice signals, can access a mobile communication network, and can wirelessly access an access point (AP).

2. Description of the Related Art

Conventional Internet-based communication terminals such as wireless wireless Voice over Internet protocol (VoIP) terminals or wireless VoIP terminals can be used only in limited areas.

Due to recent developments in mobile communication technology, mobile communication terminals are now being able to communicate with one another using a mobile communication system and using space propagation regardless of users' locations, and thus, a variety of communication services are being provided without almost any spatial restrictions.

In the meantime, conventional communication terminals are generally constituted by narrowband voice codecs and devices that support only a narrowband. Thus, such narrowband communication terminals can only be used in limited areas and may not be able to provide high-quality communication services. For example, conventional narrowband communication terminals cannot provide sounds with a band of about 6 kHz such as the sounds of crickets.

### SUMMARY OF THE INVENTION

The present invention provides a fixed mobile convergence (FMC) communication apparatus using a wideband voice codec, which can provide almost unlimited access to the Internet without any spatial restrictions and can perform Internet-based voice communication and multimedia communication using a wireless Internet by processing more than one wireless communication protocol, supporting wideband voice codecs, processing wideband voice signals, accessing a mobile communication network, and wirelessly accessing an access point (AP).

According to an aspect of the present invention, there is provided an FMC communication apparatus using a wideband voice codec, the FMC communication apparatus including an application processor which is capable of processing one or more wireless communication protocols and supports a wideband audio codec; a wideband audio signal input/output (I/O) unit which is connected to the application processor and processes the input and output of wideband audio signals; a mobile network access unit which is connected to the application processor and accesses a mobile communication network; and a wireless local area network (LAN) access unit which is connected to the application processor and wirelessly accesses an access point (AP).

### BRIEF DESCRIPTION OF THE DRAWINGS

The above and other features and advantages of the present invention will become more apparent by describing in detail preferred embodiments thereof with reference to the attached drawings in which:

FIG. 1 illustrates a schematic diagram showing how a fixed mobile convergence (FMC) communication apparatus using a wideband voice codec, according to an exemplary embodiment of the present invention, can access an access point (AP);

FIG. 2 illustrates a schematic diagram showing how the FMC communication apparatus shown in FIG. 1 can access a mobile communication network;

FIG. 3 illustrates a block diagram of the FMC communication apparatus shown in FIG. 1 or 2;

FIG. 4 illustrates a block diagram of an application processor shown in FIG. 3; and

FIG. 5 illustrates a block diagram of a wideband voice signal input/output (I/O) unit shown in FIG. 3.

### DETAILED DESCRIPTION OF THE INVENTION

The present invention will hereinafter be described in detail with reference to the accompanying drawings in which exemplary embodiments of the invention are shown.

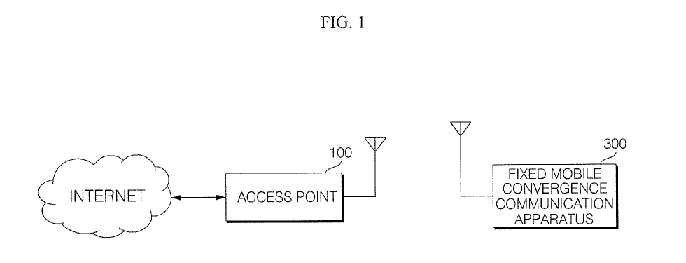

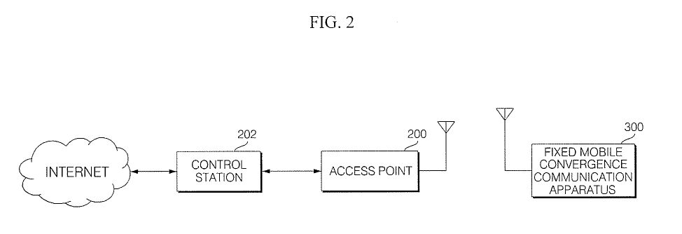

FIG. 1 illustrates a schematic diagram showing how a fixed mobile convergence (FMC) communication apparatus 300 using a wideband voice codec, according to an exemplary embodiment of the present invention, can access an access point (AP), and FIG. 2 illustrates a schematic diagram showing how the FMC communication apparatus 300 can access a mobile communication network.

Referring to FIG. 1, the FMC communication apparatus 300 may wirelessly access an AP 100 in its vicinity.

Referring to FIG. 2, the FMC communication apparatus 300 may wirelessly access either a radio access station (RAS), a radio network controller (RNS) or a base transceiver station (BTS).

More specifically, the FMC communication apparatus 300 may transmit data to or receive data from a base station 200 managing wireless resources. The base station 200 may be connected to a control station 202 controlling and managing a plurality of base stations. The control station 202 may be connected to an exchanger performing a switching operation in connection with a communication network and performing other general operations related to call processing and data exchange.

Therefore, the FMC communication apparatus 300 can wirelessly perform a voice communication function and a multimedia Internet-access function in an indoor environment, for example, in an office or home or in an outdoor environment and can provide high-quality voice call services and a variety of multimedia Internet services.

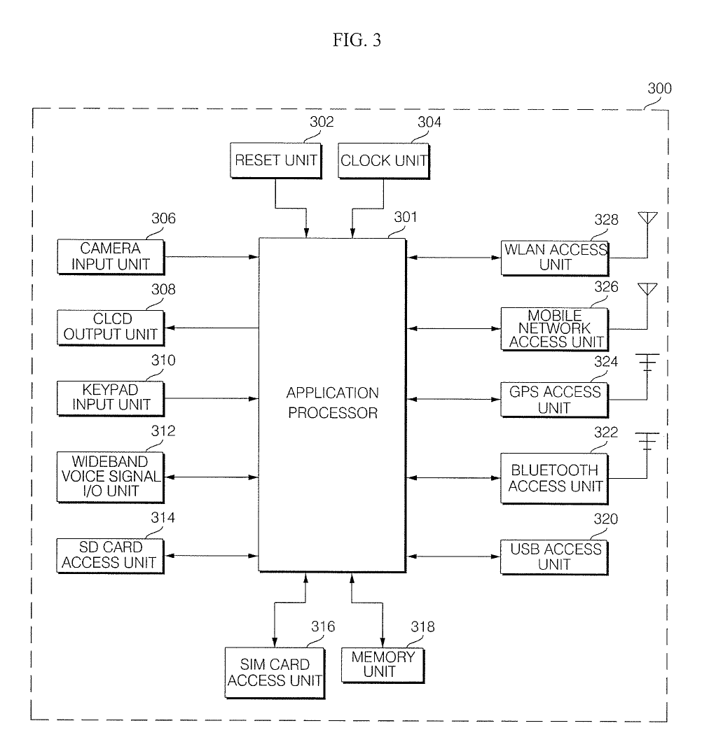

FIG. 3 illustrates a block diagram of the FMC communication apparatus 300 shown in FIG. 1 or 2. Referring to FIG. 3, the FMC communication apparatus 300 may include an application processor 301, a reset unit 302, a clock unit 304, a camera input unit 306, a color liquid crystal display (CLCD) output unit 308, a keypad input unit 310, a wideband voice signal input/output (I/O) unit 312, a secure digital (SD) card access unit 314, a subscriber identification module (SIM) card access unit 316, a memory unit 318, a universal serial bus (USB) access unit 320, a Bluetooth access unit 322, a global positioning system (GPS) access unit 324, a mobile network access unit 326, and a wireless local area network (WLAN) access unit 328.

The reset unit 302 may supply a power input reset signal and a switch reset signal to the application processor 301 for a predetermined amount of time (e.g., 140 ms).

The clock unit 304 may supply a clock necessary for the FMC communication apparatus 300, for example, a 26 MHz clock and a 32.768 kHz clock. The clock supplied by the clock unit 304 may be input to the application processor 301 and may then be supplied to other parts of the FMC communication apparatus 300 after being divided and/or multiplied.

The camera input unit 306 may use a color complementary metal oxide semiconductor (CMOS) or charge-coupled device (CCD) image sensor and may thus receive an image from a user. The camera input unit 306 may apply an 8-bit camera data signal, a camera data clock, a camera data strobe signal, a camera data vertical synchronization signal, a camera data horizontal synchronization signal, a serial control data signal, and a serial control data clock signal to the application processor 301. Camera lenses with various resolutions may be connected to the camera input unit 306.

The CLCD output unit 308 may include a CLCD module. The CLCD output unit 308 may receive a CLCD data signal, which is up to 24 bits long, a CLCD data clock, a CLCD data enable signal, a CLCD vertical synchronization signal, and a CLCD horizontal synchronization signal from the application processor 301 and may display various messages and image data to the user. More specifically, the CLCD output unit 308 may display a current state of a phone, a calling number and a called number, current time information, date information, and received signal intensity information. However, the messages that can be displayed by the CLCD output unit 308 are not restricted to those set forth herein. The CLCD output unit 308 may include a backlight module. A light-emitting diode (LED) may be used as the backlight module.

The keypad input unit 310 may include twelve basic key buttons for dialing a regular phone number or a special phone number and sixteen function key buttons for performing additional functions. The function key buttons may include a menu key, an enter key, a key for making a call, a key for terminating a call, a function-setting key, and keys for increasing or reducing speaker volume.

The wideband voice signal I/O unit 312 may include a wideband headset connection module, a microphone input module and a speaker output module which can all handle wideband voice signals with a band of 50 Hz-7000 Hz and may thus provide high-quality voice and audio signals.

An SD card data signal, an SD card command signal, an SD card clock signal, and an SD card write-protection signal may be transmitted between the SD card access unit 314 and the application processor 301. The SD card access unit 314 may transmit data to or receive data from an SD card.

A SIM card reset signal, a SIM card data clock signal, a SIM card data signal, and a SIM card detection signal may be transmitted between the SIM card access unit 316 and the application processor 301. The SIM card access unit 316 may transmit data to or receive data from an SIM card.

The memory unit 318 may be directly connected to the application processor 301 and may store a startup program or an operating program. The memory unit 318 may include a NOR flash read only memory (FROM) that can be connected to the application processor 301 by an 8-, 16- or 32-bit bus, a NAND FROM that can be connected to the application processor 301 by an 8-bit bus, a double data rate (DDR) synchronous dynamic random access memory (SDRAM) that temporarily stores user data and various application programs and can be connected to the application processor 301 by a 32-bit bus, or a pseudo random access memory (PSRAM) that can be connected to the application processor 301 by an 8-, 16- or 32-bit bus. An external device that can be accessed as a memory map may be connected to the memory unit 318.

The USB access unit 320 may constitute a USB on-the-go (OTG) port whose function is defined by a device connected thereto and may use a USB OTG transceiver. An input data signal, an output data signal, a data enable signal, an interrupt signal, a serial data clock signal, and a serial data signal may be transmitted between the USB access unit 320 and the application processor 301. In addition, a differential plus data signal ODP and a differential minus data signal ODM may be transmitted between the USB access unit 320 and the USB OTG port. The USB access unit 320 may transmit or receive data. The level of an identifier (ID) pin of the USB OTG port may determine whether the operating mode of the USB access unit 320 is a host mode or a device mode.

The Bluetooth access unit 322 may wirelessly connect the FMC communication apparatus 300 to an external Bluetooth device using a Bluetooth protocol. The Bluetooth access unit 322 may include devices for converting the level of signals, converting data or performing control. A Bluetooth transmitted data signal, a Bluetooth received data signal, a transmission request signal, a transmission confirmation signal, a control clock signal, and a control data signal may be transmitted between the Bluetooth access unit 322 and the application processor 301. The Bluetooth access unit 322 may transmit or receive data.

The GPS access unit 324 may include a GPS reception module receiving GPS data. A GPS transmitted data signal, a GPS received data signal, a transmission request signal, a transmission confirmation signal, a control clock signal, and a control data signal may be transmitted between the GPS access unit 324 and the application processor 301. The GPS access unit 324 may transmit or receive data.

An address signal, a data signals, a chip enable signal, an output enable signal, a write enable signal, a ready signal, a 16-bit I/O signal, a reset signal, an I/O device channel ready signal, a diagnosis complete signal, an active signal, an I/O device read signal, an I/O device write signal, a voltage sensing signal, and a card detection signal may be transmitted between the mobile network access unit 326 and the application processor 301. The mobile network access unit 326 may process data to be transmitted by a mobile Internet system (e.g., Wibro or WiMAX) or a mobile communication system (e.g., WCDMA, HSDPA, HSUPA, LTE or UWB).

An SDIO data signal, an SDIO command signal, an SDIO clock signal, and an SDIO write-protection signal may be transmitted between the WLAN access unit 328 and the application processor 301. The WLAM access unit 328 may process data to be wirelessly transmitted through a WLAN.

The application processor 301 may include a processor core module. The application processor 301 is a core element of the FMC communication apparatus 300 for processing various communication protocols for communicating with other parts in the FMC communication apparatus 300 and performing a FMC communication function in a software or hardware manner.

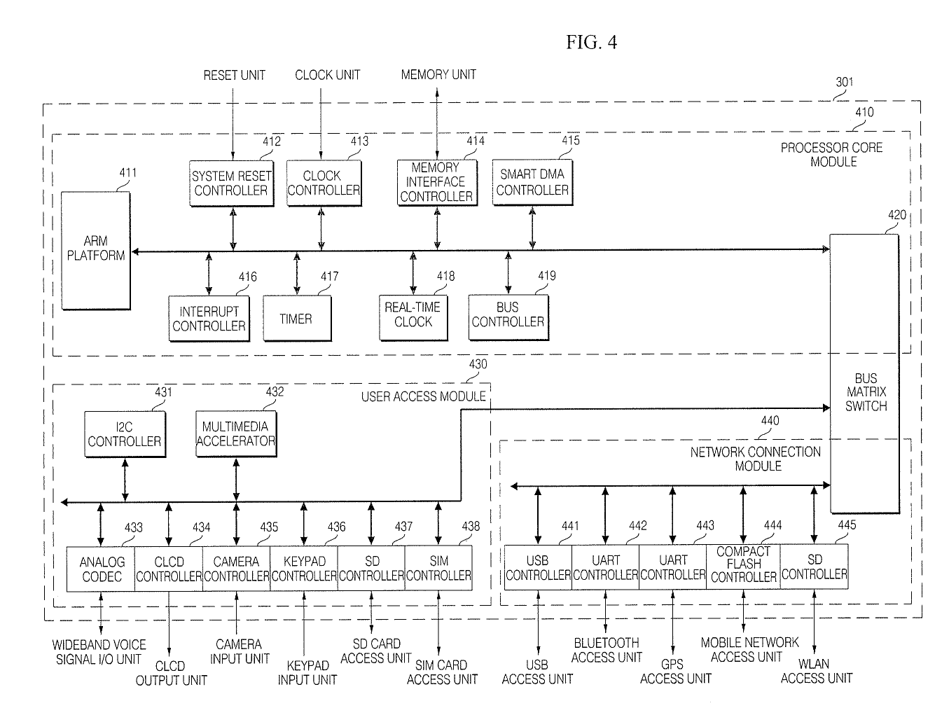

FIG. 4 illustrates a block diagram of the application processor 301 shown in FIG. 3. Referring to FIG. 4, the application processor 301 may include a processor core 410, a user access module 430, and a network connection module 440.

The process core module 410 may include an ARM platform 411, a system reset controller 412, a clock controller 413, a memory interface controller 414, a smart direct memory access (DMA) controller 415, an interrupt controller 416, a timer 417, a real-time clock 418, and a bus controller 419, which are all connected to an internal bus. The process core module 410 may be connected to a bus matrix switch 420.

The user access module 430 may include an inter-integrated circuit (12C) controller 431, a multimedia accelerator 432, an analog codec 433, a CLCD controller 434, a camera controller 435, a keypad controller 436, an SD controller 437, and a SIM controller 438, which are all connected to an internal bus.

The network connection module 440 may include a USB controller 441, universal asynchronous receiver/transmitter (UART) controllers 442 and 443, a compact flash (CF) controller 444 and an SD controller 445, which are all connected to an internal bus.

The ARM platform 411, which is a 32-bit RISC microprocessor, may provide an instruction cache function, a data cache function, a memory management unit (MMU) function and a boot-ROM function and may serve as a central processing unit (CPU) for the application processor 301.

The system reset controller 412 may be connected to the reset unit 302. Thus, the system reset controller 412 may initialize all circuits in the application processor 301 in response to a reset signal applied thereto from the reset unit 302. In addition, the system reset controller 412 may generate a reset signal for each controller in the application processor 301 and may transmit the generated reset signal via a bus.

The clock controller 413 may be connected to the clock unit 304. Thus, the clock controller 413 may receive a 26 MHz clock signal from the clock unit 304, and may generate various clock signals based on the received clock signal using a phase-lock loop (PLL). In addition, the clock controller 413 may receive a 32.768 MHz clock signal from the clock unit 304, and may generate a real-time clock signal based on the received clock signal.

The memory interface controller 414 may generate a control signal for reading data from or writing data to a flash memory, a SDRAM, or an external device connected to the application processor 301 as a memory map.

The smart DMA controller 415 may generate and provide a control signal for quickly transmitting data between a controller and a memory without a requirement of a processor. The smart DMA controller 415 may acquire the rights of a master from a processor and may thus transmit data.

The interrupt controller 416 may process internal or external interrupts resulting from the execution of programs according to their priority levels.

The timer 417 may receive a reference clock signal and may generate an appropriate timing signal at a time designated by a program. In addition, the timer 417 may generate an interrupt at regular intervals of time in order to monitor the execution of a program.

The real-time clock 418 may keep track of the current time in units of 1 Hz clock signals by dividing a 32.768 kHz clock signal.

The bus controller 419 may allow various signals such as a data signal, an address signal and a control signal to be properly transmitted via multiple buses according to their timing requirements.

The bus matrix switch 420 may quickly switch master buses and slave buses.

The multimedia accelerator 432 may pre- and/or post-process image data and may encode and/or decode image data using a standard video codec.

The analog codec 433 may convert an input analog signal into pulse code modulation (PCM) data by sampling the input analog signal at a frequency of 8 kHz or 16 kHz, and may transmit the PCM data to a processor. In addition, the analog codec 433 may convert PCM data provided by a processor into analog data by sampling the PCM data at a frequency of 8 kHz or 16 kHz, and may output the analog data.

The CLCD controller 434 may generate CLCD data, a synchronization signal and a clock signal so that color data information can be output to the CLCD output unit 308 at high speed.

The camera controller 435 may receive an image from an external image source such as a CMOS or CCD sensor and may process the received image.

The keypad controller 436 may scan a keypad matrix connected thereto, thereby reducing the burden of software.

The SD controller 437 may be connected to a memory card such as an SD card or an external device.

The SIM controller 438 may be connected to a SIM card having subscriber identification information.

The USB controller 441 may process serial data at high speed using the USB 2.0 standard so that the processed serial data can be transmitted via a USB port.

The UART controllers 442 and 443 may control data input thereto or output therefrom in series and may process data according to a UART protocol.

The CF controller 444 may be connected to a memory card such as a CF card or an external device.

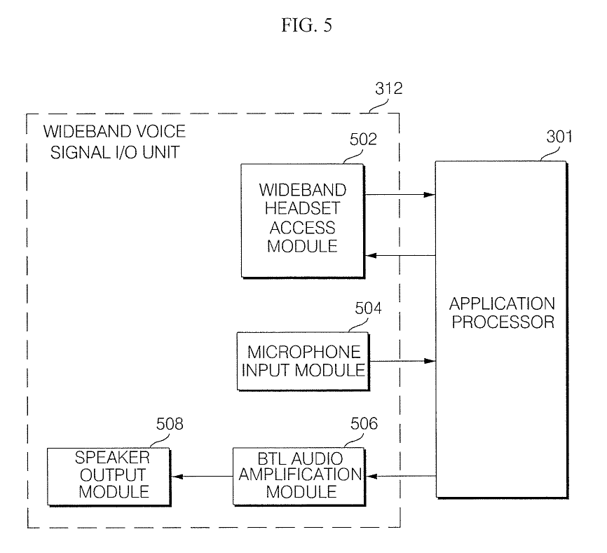

FIG. 5 illustrates a block diagram of the wideband voice signal I/O unit 312. Referring to FIG. 5, the wideband voice signal I/O unit 312 may include a wideband headset connection module 502, a microphone input module 504, a speaker output module 508 and a bridge-tied logic (BTL) audio amplification module 506. The wideband voice signal I/O unit 312 may be connected to the application processor 301.

The wideband headset connection module 502 may be connected to a receiver receiving audio signals and a microphone transmitting voice signals. The receiver and the microphone may support a band of 50 Hz to 7000 Hz so as to be able to process wideband audio signals.

The microphone input module 504 may receive audio signals and may include a microphone supporting wideband audio signals. If the microphone input module 504 uses a static condenser-type microphone, a bias voltage and a ground voltage may both need to be supplied to an audio signal line.

The speaker output module 508 may receive a BTL signal provided by the BTL audio amplification module 506 and may output the received BTL signal. The speaker output module 508 may use a speaker supporting wideband audio signals. A plus output signal and a minus output signal may both be applied to the speaker output module 508, and may be added up by the speaker output module 508. Then, the speaker output module 508 may output the result of the addition.

The BTL audio amplification module 506 may receive a signal from the application processor 301, and may amplify the received signal using an external amplification resistor in order to drive an external speaker.

As described above, according to the present invention, the FMC communication apparatus according to the present invention can provide high-quality voice call services and multimedia internet services by accessing the internet using various wireless communication methods. In addition, it is possible to easily implement a communication terminal capable of performing various functions requested by a user simply by modifying the functions of the FMC communication apparatus according to the present invention or adding new functions to the FMC communication apparatus according to the present invention. For example, the FMC communication apparatus according to the present invention may be easily transformed into a mobile internet protocol television (IPTV) set by installing an IPTV program in the FMC communication apparatus according to the present invention. The FMC communication apparatus according to the present invention may be easily transformed into a digital multimedia broadcasting (DMB) terminal device by adding a DMB receiver to the FMC communication apparatus according to the present invention. The FMC communication apparatus according to the present invention may be easily transformed into a fourth generation (4G) wireless terminal device by adding a long-term evolution (LTE) device or a ultra wideband (UWB) device to the FMC communication apparatus according to the present invention. The FMC communication apparatus according to the present invention may be easily transformed into a monitoring device by adding a camera remote-control module to the FMC communication apparatus according to the present invention.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A fixed mobile convergence (FMC) communication apparatus using a wideband voice codec, the FMC communication apparatus comprising:
an application processor which is capable of processing one or more wireless communication protocols and supports a wideband audio codec;
a wideband audio signal input/output (I/O) unit which is connected to the application processor and processes the input and output of wideband audio signals;
a mobile network access unit which is connected to the application processor and accesses a mobile communication network; and
a wireless local area network (LAN) access unit which is connected to the application processor and wirelessly accesses an access point (AP).

2. The FMC communication apparatus of claim 1, wherein the wideband audio signal I/O unit comprises at least one of a wideband headset access module, a microphone input module, a speaker output module and a bridge-tied logic (BTL) audio amplification module for receiving or inputting wideband audio signals.

3. The FMC communication apparatus of claim 1, further comprising:
a reset unit which supplies a reset signal to the application processor;
a clock unit which supplies a clock signal to the application processor;
a keypad input unit which is connected to the application processor and receives control information of a user;
a memory unit which is connected to the application processor and stores at least one of a startup program, an operating program, an application program and user data; and
a color liquid crystal display (CLCD) output unit which is connected to the application processor and outputs information necessary for the user and an image.

4. The FMC communication apparatus of claim 1, further comprising a camera input unit which is connected to the application processor and receives image information of a user.

5. The FMC communication apparatus of claim 1, further comprising:
a secure digital (SD) card access unit which is connected to the application processor and accesses an SD card; and
a subscriber identification module (SIM) card access unit which is connected to the application processor and accesses a SIM card.

6. The FMC communication apparatus of claim 1, further comprising a Bluetooth access unit which is connected to the application processor and accesses a Bluetooth device.

7. The FMC communication apparatus of claim 1, further comprising a global positioning system (GPS) access unit which is connected to the application processor and accesses a GPS device.

8. The FMC communication apparatus of claim 1, wherein the application processor comprises a processor core module which includes an ARM platform and controls the FMC communication apparatus, a user access module which receives data from or outputs data to a user, and a network connection module which connects the application processor to a network.

9. The FMC communication apparatus of claim 8, wherein the user access module includes at least one of an analog codec, a CLCD controller, a camera controller, a keypad controller, a SIM controller, an SD controller and a multimedia accelerator.

10. The FMC communication apparatus of claim 8, wherein the network connection module includes at least one of a universal asynchronous receiver/transmitter (UART) controller, a universal serial bus (USB) controller, an SD controller and a compact flash (CF) controller.
